(19) United States
(12) Patent Application Publication
(10) Pub. No.: US 2011/0076067 A1
(43) Pub. Date: Mar. 31, 2011

(54) FIXING APPARATUS AND IMAGE FORMING APPARATUS

(75) Inventors: Yoshiyuki NAGAI, Shiojiri (JP); Kenjiro YOSHIOKA, Shiojiri (JP); Katsuhito GOMI, Chino (JP)

(73) Assignee: SEIKO EPSON CORPORATION, Tokyo (JP)

(21) Appl. No.: 12/883,694

(22) Filed: Sep. 16, 2010

(30) Foreign Application Priority Data
Sep. 30, 2009 (JP) 2009-226422

(51) Int. Cl. G03G 15/20

(52) U.S. Cl. 399/322; 399/328; 399/341

(57) ABSTRACT

A fixing apparatus for forming an image on a transfer material includes first and second fixing roller units, a suction guide, and a movement member. The first fixing roller unit includes a first heating roller that heats the transfer material bearing the image and a first pressure roller being in contact with the first heating roller. The suction guide guides the transfer material, and includes a suction surface that vertically upwardly sucks the transfer material after being heated by the first fixing roller unit. The second fixing roller unit fixes the transfer material after being guided by the suction guide, and includes a second heating roller heating the transfer material and a second pressure roller being in contact with the second heating roller. The second pressure roller is disposed above the second heating roller in the vertical direction. The movement member causes the second pressure roller to move vertically upwardly.

### CROSS-REFERENCE TO THE RELATED APPLICATIONS

This application claims priority to Japanese Patent Application No. 2009-226422 which was filed on Sep. 30, 2009. The entire discloser of Japanese Patent Application No. 2009-226422 is hereby incorporated herein by reference.

### BACKGROUND

1. Technical Field

The present invention relates to fixing apparatuses and image forming apparatuses that handle electrophotography.

2. Related Art

A fixing device, in an image forming apparatus, that includes a first fixing unit fixing an image transferred onto a transfer material, a second fixing unit that fixes after the first fixing, and a bypass transport path in which the transfer material that has passed through the first fixing unit does not pass through the second fixing unit, has been disclosed in the past. Japanese Patent Application Publication No. 2006-308889 discloses such fixing device.

In addition, an image forming apparatus that includes a first fixing unit and a second fixing unit and that adjusts the temperature of a heating roller of the first fixing unit based on transfer material information has been disclosed as well. Japanese Patent Application Publication No. 2008-90115 discloses such image forming apparatus.

However, the image forming apparatus according to Japanese Patent Application Publication No. 2006-308889 also includes a curl application unit that corrects curls arising due to heat contraction of the toner and the like and a flapper that switches transport paths. Consequently, the image forming apparatus increases in the size and complexity of the apparatus. Furthermore, there have been situations where rollers, the flapper, and so on have made contact with the image surface immediately after the fixing, when the image surface is still in a high-temperature state. This results in having different glossiness in the areas of the image where the contact was made from the rest of the image; the quality of the image has thus dropped as a result.

Meanwhile, with the image forming apparatus according to Japanese Patent Application Publication No. 2008-90115, adjusting the temperature of the fixing device takes time, particularly when decreasing the temperature thereof. Consequently, the productivity of the apparatus drops.

### SUMMARY

An advantage of some aspects of the invention is to provide a fixing apparatus for reducing the influence of heat from a second fixing roller on the surface of an image while employing a simple structure, and an image forming apparatus capable of forming a favorable image.

A fixing apparatus for forming an image on a transfer material is provided to solve the above mentioned problems.

The fixing apparatus includes first and second fixing roller units, a suction guide, and a movement member. The first fixing roller unite includes a first heating roller that heats the transfer material bearing the image and a first pressure roller that is in contact with the first heating roller.

The suction guide guides the transfer material. The suction guide includes a suction surface that vertically upwardly sucks the transfer material after being heated by the first fixing roller unit with a surface of the transfer material that bears the image facing vertically down.

The second fixing roller unit fixes the transfer material after being guided by the suction guide. The second fixing roller unit includes a second heating roller that heats the transfer material, and a second pressure roller that is disposed above the second heating roller in the vertical direction and is in contact with the second heating roller.

The movement member causes the second pressure roller to move vertically upwardly.

### BRIEF DESCRIPTION OF THE DRAWINGS

The invention will be described with reference to the accompanying drawings. The same reference numbers apply to similar elements.

FIG. 1 is a diagram illustrating a first embodiment of an image forming apparatus.

FIG. 2 is a diagram illustrating an example of the vicinity of a second fixing roller pair of a fixing unit according to the first embodiment.

FIG. 3 is a diagram illustrating a state in which a second pressure roller in a second fixing roller pair has moved upward in the vertical direction, according to the first embodiment.

FIG. 4 is a cross-sectional view taken perpendicular to the axial direction of a fixing unit that is in the state shown in FIG. 2.

FIG. 5 is a cross-sectional view taken perpendicular to the axial direction of a fixing unit that is in the state shown in FIG. 3.

FIG. 6 is a cross-sectional view illustrating an example of the vicinity of a fixing unit according to a second embodiment.

FIG. 7 is a cross-sectional view illustrating a state in which a second pressure roller in a second fixing roller pair has moved upward in the vertical direction, according to the second embodiment.

FIGS. 8A to 8C are diagrams illustrating examples in which the shape of a fixing unit suction surface in a fixing unit suction guide has been changed, according to the second embodiment.

FIG. 9 is a diagram illustrating a fixing unit suction guide according to a third embodiment.

FIG. 10 is a plan view illustrating the fixing unit suction guide according to the third embodiment.

FIG. 11 is a diagram illustrating a fixing unit suction guide according to a fourth embodiment.

### DETAILED DESCRIPTION OF PREFERRED EMBODIMENTS

Embodiments of the invention will now be described in terms of the explanatory embodiment with reference to the drawings.

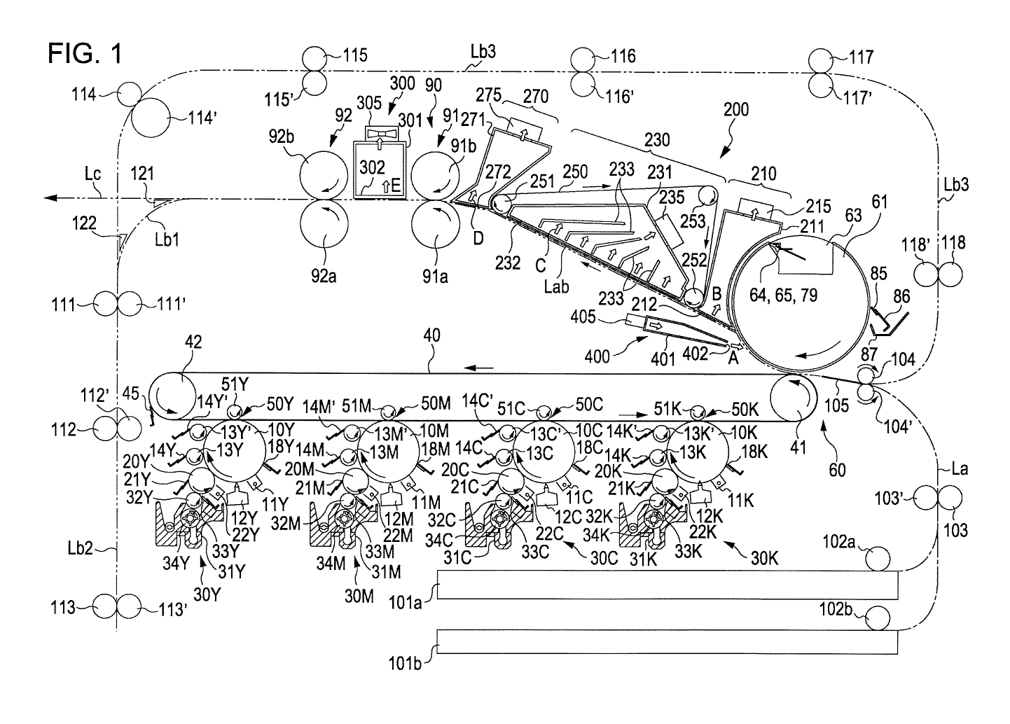

FIG. 1 is a diagram illustrating the primary constituent elements of which an image forming apparatus according to a first embodiment of the invention is configured. Developing units 30Y, 30M, 30C, and 30K serving as developing units are disposed in a lower portion of the image forming apparatus, opposing an intermediate transfer belt 40 and serving as a transfer medium. The developing units 30Y, 30M, 30C, and 30K are disposed in a central portion of the image forming apparatus. A secondary transfer unit 60 serving as a transfer unit, a fixing unit 90 serving as a fixing unit, and so on are disposed in an upper portion of the image forming apparatus. In particular, the fixing unit 90 is configured above the intermediate transfer belt 40, and thereby makes it possible to reduce the installation footprint of the image forming apparatus as a whole.

First, units surrounding photosensitive members will be described. Photosensitive members 10Y, 10M, 10C, and 10K, are provided. Each serving as a latent image bearing member and each configured of a cylindrically-shaped member on the outer circumferential surface of which a photosensitive layer such as an amorphous silicon photosensitive member is formed. And the following elements are disposed in the respective surrounding areas thereof. In the rotational direction of the outer circumference of the photosensitive members 10Y, 10M, 10C, and 10K, the elements are: corona charging units 11Y, 11M, 11C, and 11K; exposure units 12Y, 12M, 12C, and 12K; developing rollers 20Y, 20M, 20C, and 20K serving as developer holding members for the developing units 30Y, 30M, 30C, and 30K; first photosensitive member squeeze rollers 13Y, 13M, 13C, and 13K; second photosensitive member squeeze rollers 13Y′, 13M′, 13C′, and 13K′; primary transfer units 50Y, 50M, 50C, and 50K; discharge units (not shown); and photosensitive member cleaning blades 18Y, 18M, 18C, and 18K. Note that in an image formation process, elements disposed earlier in the order from the corona charging units 11Y, 11M, 11C, and 11K to the photosensitive member cleaning blades 18Y, 18M, 18C, and 18K are defined as being upstream from elements disposed later in the stated order.

With the units surrounding the photosensitive members, first, the photosensitive members 10Y, 10M, 10C, and 10K are uniformly charged by the corona charging units 11Y, 11M, 11C, and 11K, which are disposed further upstream in the rotational direction of the photosensitive members 10Y, 10M, 10C, and 10K than nip portions formed between the photosensitive members 10Y, 10M, 10C, and 10K and the developing rollers 20Y, 20M, 20C, 20K. Then, the exposure units 12Y, 12M, 12C, and 12K, which are disposed downstream from the corona charging units 11Y, 11M, 11C, and 11K and upstream from nip portions formed between the photosensitive members 10Y, 10M, 10C, and 10K and the developing rollers 20Y, 20M, 20C, and 20K carry out exposure based on inputted image signals to form electrostatic latent images by irradiating the surfaces of the charged photosensitive members 10Y, 10M, 10C, and 10K.

Next, the developing units 30Y, 30M, 30C, and 30K will be described. In the developing units 30Y, 30M, 30C, and 30K, augers 34Y, 34M, 34C, and 34K that agitate and transport liquid developers of various colors held within developer reservoirs 31Y, 31M, 31C, and 31K supply the liquid developers to anilox rollers 32Y, 32M, 32C, and 32K serving as developer supply members. Next, the anilox rollers 32Y, 32M, 32C, and 32K apply the liquid developers of the respective colors to the developing rollers 20Y, 20M, 20C, and 20K. The amount of the liquid developers having been regulated by regulating blades 33Y, 33M, 33C, and 33K.

The liquid developers held on the developing rollers 20Y, 20M, 20C, and 20K are put into a state of compaction by compaction corona generators 22Y, 22M, 22C, and 22K. Then, the electrostatic latent images formed upon the photosensitive members 10Y, 10M, 10C, and 10K are developed and toner images are formed upon the photosensitive members 10Y, 10M, 10C, and 10K. Liquid developer that has remained on the developing rollers 20Y, 20M, 20C, and 20K is cleaned off by developing roller cleaning blades 21Y, 21M, 21C, and 21K.

The liquid developer held in the developer reservoir 31Y is a non-volatile liquid developer, which is non-volatile at normal temperatures, and which has a high concentration and high viscosity rather than a volatile liquid developer that uses Isopar (an Exxon brand) as its carrier, which is volatile at normal temperatures. The volatile liquid developer with Isopar has a low concentration (approximately 1-3 wt %), and has a low viscosity, as it has generally been used in the past. In other words, the liquid developer in the invention is a high-viscosity liquid developer (that is, a viscoelasticity of approximately 30 to 300 mPa·s at a shear rate of 1000 (1/s) at 25° C., measured using a HAAKE RheoStress RS600) with a toner solid content concentration of approximately 15 to 25%, in which solid particles of a colorant such as a pigment having an average particle diameter of 1 μm are dispersed within a thermoplastic resin and are added to a liquid carrier such as an organic carrier, silicon oil, mineral oil, or cooking oil along with a dispersant.

The toner images formed upon the photosensitive members 10Y, 10M, 10C, and 10K are squeezed by the first photosensitive member squeeze rollers 13Y, 13M, 13C, and 13K and the second photosensitive member squeeze rollers 13Y′, 13M′, 13C′, and 13K′.

The intermediate transfer belt 40 is a belt, formed of a seamless elastic member such as rubber, which is stretched across a belt driving roller 41 and a tension roller 42. The intermediate transfer belt 40 is rotationally driven by the belt driving roller 41 while making contact with the photosensitive members 10Y, 10M, 10C, and 10K at the primary transfer units 50Y, 50M, 50C, and 50K. The primary transfer units 50Y, 50M, 50C, and 50K form a full-color toner image by sequentially transferring the developed toner images of the stated colors upon the photosensitive members 10Y, 10M, 10C, and 10K onto the intermediate transfer belt 40 by superimposing the toner images on one another. The primary transfer units 50Y, 50M, 50C, and 50K use the positions where the intermediate transfer belt 40 makes contact with the photosensitive members 10Y, 10M, 10C, and 10K. The intermediate transfer belt 40 is located between the photosensitive members 10Y, 10M, 10C, and 10K and primary transfer rollers 51Y, 51M, 51C, and 51K as the transfer positions.

Liquid developer that has remained on the photosensitive members 10Y, 10M, 10C, and 10K after passing through the primary transfer units 50Y, 50M, 50C, and 50K is removed by using a discharge unit (not shown), the photosensitive member cleaning blades 18Y, 18M, 18C, and 18K, and so on.

Note that the disposition order of the photosensitive members, the elements of the developing units, and so on with respect to the Y, M, C, and K colors is not limited to the order illustrated in FIG. 1. The order may be set as desired.

Next, the transfer of a toner image from the intermediate transfer belt 40 to a transfer material S will be described.

The transfer material S is supplied to the image forming apparatus by a paper supply unit. The transfer material S, which has been set in a first paper supply tray 101a or a second paper supply tray 101b, is transported to a paper supply transport path La at a predetermined timing, one respective sheet at a time, by a first paper supply roller 102a or a second paper supply roller 102b. Meanwhile, in a transfer material transport path Lab, the transfer material S is transported to a secondary transfer position by a pair of gate rollers 104 and 104′ and a transfer material guide 105.

The secondary transfer unit 60 includes a secondary transfer roller 61 serving as a transfer member, and a secondary transfer roller cleaning blade 85 that cleans the secondary transfer roller 61. The secondary transfer roller 61 rotates along with the belt driving roller 41 in the direction indicated by the arrow, and a transfer bias is applied thereto.

The leading edge of the transfer material S transported by the transfer material guide 105 is caught by a gripper 64 serving as a transfer material catching unit provided within a concave portion 63 extending in the axial direction of the secondary transfer roller 61, and a gripper support portion 65 serving as a transfer material catching unit receiving portion on which the gripper 64 is mounted; thus the transfer material S is positioned relative to the secondary transfer roller 61 and moves with certainty toward a transfer nip as the secondary transfer roller 61 rotates.

The toner image on the intermediate transfer belt 40 is transferred to the transfer material S, which is paper, film, cloth, or the like, at the transfer nip. When a catching portion of the gripper 64 and the leading edge of the transfer material S pass through the transfer nip, the gripper 64 commences movement in a direction away from a claw support member 65, and the leading edge of the transfer material S is released as a result. Then, a protruding claw 79 is set to a protruding position as the secondary transfer roller 61 rotates further, and thus the transfer material S separates from the secondary transfer roller 61.

Meanwhile, the transfer material S that was released from the gripper 64 is lightly pressed against the secondary transfer roller 61 by air blown from a blowing unit 400 that expels air, in the direction indicated by an arrow A, from an opening portion 402 in a housing unit 401. The air is expelled through the operation of an airflow generation unit 405; the transfer material S is also pressed in a direction away from the secondary transfer roller 61 by the protruding claw 79.

In this manner, the transfer material S pinched by the nip portion between the belt driving roller 41 and the secondary transfer roller 61 moves to a transfer material transport unit 200, in the order from the leading edge to the trailing edge, due to further rotation of the belt driving roller 41 and the secondary transfer roller 61. In other words, the portion of the transfer material S for which transfer is complete separates while the toner image on the intermediate transfer belt 40 undergoes the secondary transfer onto the transfer material S.

According to this configuration, it is possible to prevent the trailing edge of the transfer material S from making contact with the intermediate transfer belt 40 or the like and the image formed thereupon from being soiled, when the trailing edge of the transfer material S is discharged from a secondary transfer nip. Note that the air blowing performed by the blowing unit 400 may be omitted, if where the transfer material S has a low elastic restitution force and is flimsy.

Next, transport of the post-secondary transfer transfer material S will be described.

A first suction device 210, a transfer material transport device 230, and a second suction device 270 are disposed in that order, as the transfer material transport unit 200, downstream from the secondary transfer unit 60 in the transfer material transport path Lab, and serve to transport the transfer material S to the fixing unit 90.

The post-secondary transfer material S is held on a suction surface 212 of a housing portion 211, without falling, as a result of a suction force B from the suction surface 212 that is generated through the operation of an airflow generation unit 215 of the first suction device 210, and is transported along the suction surface 212, by the force of a feeding operation, from the side of the secondary transfer unit 60.

As a result of the force of the feeding operation from the side of the secondary transfer unit 60, the transfer material S transported along the suction surface 212 of the first suction device 210 reaches the side of the transfer material transport device 230. Next, the transfer material S is held against a transport surface by a suction force C, from a suction surface 232 of a housing portion 231, that is generated through the operation of an airflow generation unit 235 of the transfer material transport device 230. Along with this, the transfer material S advances along the transport surface toward the fixing unit 90 as a result of a transfer material transport member 250, which is wound upon a transfer material transport member driving roller 251 and transfer material transport member tension rollers 252 and 253, while the transfer martial transport member driving roller 251 performs moving operations due to driving force exerted by the transfer material transport member driving roller 251.

The transfer material S that has been transported along the transport surface of the transfer material transport device 230 is sucked as a result of a suction force D, from a suction surface 272 of a housing portion 271. The suction force D is generated through operations performed by an airflow generation unit 275 of the second suction device 270. And thus the transfer material S is transported.

Next, fixing of the toner image onto the transfer material S will be described.

In the fixing unit 90, a single-color toner image, a full-color toner image, or the like that has been transferred onto the transfer material S, such as paper or the like, is melted and fixed to the transfer material S, such as paper or the like.

The fixing unit 90 includes a first fixing roller pair 91 and a second fixing roller pair 92 located downstream from the first fixing roller pair 91. The first fixing roller pair 91 includes a first heating roller 91a that has an internal heater and a first pressure roller 91b that is biased at a predetermined pressure toward the first heating roller 91a. The transfer material S enters into a nip formed by these rollers, where a single-color toner image, a full-color toner image, or the like transferred onto the transfer material S is melted and fixed to the transfer material S, which is paper or the like. Likewise, the second fixing roller pair 92 includes a second heating roller 92a that has an internal heater and a second pressure roller 92b that is biased at a predetermined pressure toward the second heating roller 92a. The transfer material S enters into a nip formed by these rollers, where the single-color toner image, the full-color toner image, or the like transferred onto the transfer material S is melted and fixed with further strength to the transfer material S, which is paper or the like.

Furthermore, a fixing unit suction guide 300 is disposed between the first fixing roller pair 91 and the second fixing roller pair 92 of the fixing unit 90. The fixing unit suction guide 300 includes a housing portion 301, a fixing unit suction surface 302 disposed on the transfer material transport path Lab side of the housing portion 301, and an airflow generation unit 305 disposed in the housing portion 301 on the side opposite to the transfer material transport path Lab. The transfer material S is held on the fixing unit suction surface 302 without falling by a suction force E, from the fixing unit suction surface 302 of the housing portion 301. The suction force E is generated through the operation of the airflow generation unit 305, and is transported along the fixing unit suction surface 302, while being held thereon, toward the second fixing roller pair 92 by the force of the feeding operation from the first fixing roller pair 91.

By using the fixing unit suction guide 300 in this manner, the amount of moisture contained in the transfer material S is rapidly reduced by subjecting the transfer material S to a large amount of air. This can result in correcting curling. Accordingly, it is no longer necessary to provide a curl roller pair as was done in the past. And thus it is possible to reduce the size of the image forming apparatus. Furthermore, collisions between the leading edge of the transfer material S and the second heating roller 92a can be reduced by sucking the transfer material S using the fixing unit suction guide 300.

After the fixing, if it is single-sided printing, the transfer material S is transported along a discharge transport path Lc and is discharged.

On the other hand, if it is double-sided printing, the transfer material S is guided by a first flapper 121, and is transported to a first double-sided transport path Lb1. After this, the transport direction of the transfer material S is inverted in a second double-sided transport path Lb2 having a first inversion transport roller pair 111 and 111′, a second inversion transport roller pair 112 and 112′, and a third inversion transport roller pair 113 and 113′, after which the transfer material S is guided by a second flapper 122 and transported to a third double-sided transport path Lb3.

In the third double-sided transport path Lb3, the transfer material S passes through a curl application roller pair 114 and 114′ serving as a curl application unit, and then passes through a first double-sided transport roller pair 115 and 115′, a second double-sided transport roller pair 116 and 116′, a third double-sided transport roller pair 117 and 117′, and a fourth double-sided transport roller pair 118 and 118′. Next, the inverted transfer material S is transported from the pair of gate rollers 104 and 104′ and the transfer material guide 105 to the transfer material transport path Lab. After this, the transfer material S passes through the fixing unit 90, is transported to the discharge transport path Lc, and is discharged.

Detailed descriptions of the fixing unit 90 will be given hereinafter.

The first heating roller 91a and the second heating roller 92a of this embodiment according to the invention are 60 mm in diameter. The metal cores thereof are 2 mm in thickness, and the material of the metal cores is aluminum, iron, stainless steel, brass, or the like. An elastic layer is formed around the circumference of the respective metal cores. The thickness of the elastic layer is 2 mm, and the material of the elastic layer is silicon rubber, fluorocarbon rubber, urethane rubber, or the like. Furthermore, a delaminating layer is formed around the elastic layer. The delaminating layer is 30 μm thick, and the material of the delaminating layer is PFA, PTFE, FEP, ETFE, or the like.

Furthermore, the first pressure roller 91b and the second pressure roller 92b of this embodiment according to the invention are 60 mm in diameter; the metal cores thereof are 2 mm in thickness, and the material of the metal cores is aluminum, iron, stainless steel, brass, or the like. An elastic layer is formed around the circumference of the respective metal cores. The thickness of the elastic layer is 2 mm, and the material of the elastic layer is silicon rubber, fluorocarbon rubber, urethane rubber, or the like. Furthermore, a delaminating layer is formed around the elastic layer. The delaminating layer is 30 μm thick, and the material of the delaminating layer is PFA, PTFE, FEP, ETFE, or the like.

In addition, the first heating roller 91a and the second heating roller 92a are driven by a driving member (not shown), and the first pressure roller 91b and the second pressure roller 92b rotate as slaves based on the rotation of the first heating roller 91a and the second heating roller 92a, respectively.

Note that if a rigid material such as iron, aluminum, stainless steel, brass, or the like is used for the first pressure roller 91b and the second pressure roller 92b, and a soft material such a rubber layer made from silicon rubber, urethane rubber, or natural rubber, or a sponge layer made from a silicon sponge, a urethane sponge, or a melamine sponge is provided on the first heating roller 91a and the second heating roller 92a, curling in the direction of the image surface caused by heat can be corrected. In addition, it is not necessary for the second heating roller 92a and the second pressure roller 92b to be separate from each other completely. The rollers may be formed so that the applied pressure is reduced, rather than separating from each other completely.

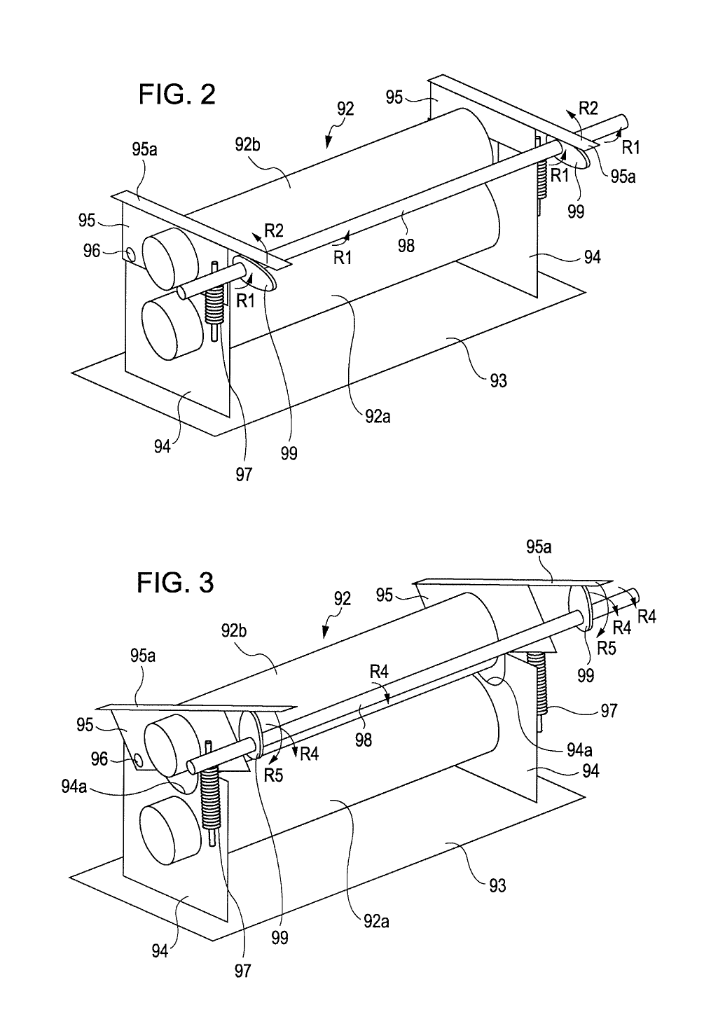

FIG. 2 is a diagram illustrating an example of the vicinity of the second fixing roller pair 92 of the fixing unit 90 according to the first embodiment.

Second heating roller anchor plates 94 that are disposed on a base 93 and that support the second heating roller 92a in a rotatable state and second pressure roller anchor plates 95 that support the second pressure roller 92b in a rotatable state are present in the vicinity of the second fixing roller pair 92. The second heating roller anchor plates 94 and the second pressure roller anchor plates 95 are linked on one side by a side plate linking shaft 96 so as to be capable of pivoting relative to a plane that contains the axis of the second heating roller 92a and the second pressure roller 92b, and are linked on the other side by a spring 97.

Furthermore, a cam shaft 98 is supported in a rotatable state by through-holes in a cam shaft support member such as a main body case or the like (not shown), and cams 99 are anchored to the cam shaft 98. The cams 99 make contact with cam contact portions 95a in the respective second pressure roller anchor plates 95.

The base 93, the second heating roller anchor plates 94, the second pressure roller anchor plates 95, the side plate linking shaft 96, the springs 97, the cam shaft 98, and the cams 99 configure a movement member. Note that the movement member is not limited to the configuration used in the first embodiment, and may be any mechanism as long as that mechanism moves the second pressure roller 92b upwardly in the vertical direction.

When the cam shaft 98 rotates in the direction of an arrow R1 starting from the state shown in FIG. 2, the cams 99 also rotate in the direction of the arrow R1. Pressure is applied to the cam contact portions 95a by the cams 99 rotating, and the second pressure roller anchor plates 95 rotate central to the side plate linking shaft 96 in the direction of an arrow R2 against the biasing force of the springs 97.

FIG. 3 is a diagram illustrating a state in which the second pressure roller 92b of the second fixing roller pair 92 has moved upwardly in the vertical direction, according to the first embodiment.

In FIG. 2, when the second pressure roller anchor plates 95 rotate in the direction of the arrow R2, the second pressure roller 92b supported by the second pressure roller anchor plates 95 moves upwardly in the vertical direction, as shown in FIG. 3. Note that in FIG. 3, 94a indicates concave portions formed so that the second pressure roller 92b and the second heating roller anchor plates 94 do not interfere with each other.

When the cam shaft 98 rotates in the direction of an arrow R4 starting from the state shown in FIG. 3, the cams 99 also rotate in the direction of the arrow R4. The cam contact portions 95a move downwardly due to the rotation of the cams 99, and the second pressure roller anchor plates 95 rotate central to the side plate linking shaft 96 in the direction of an arrow R5 due to the biasing force of the springs 97.

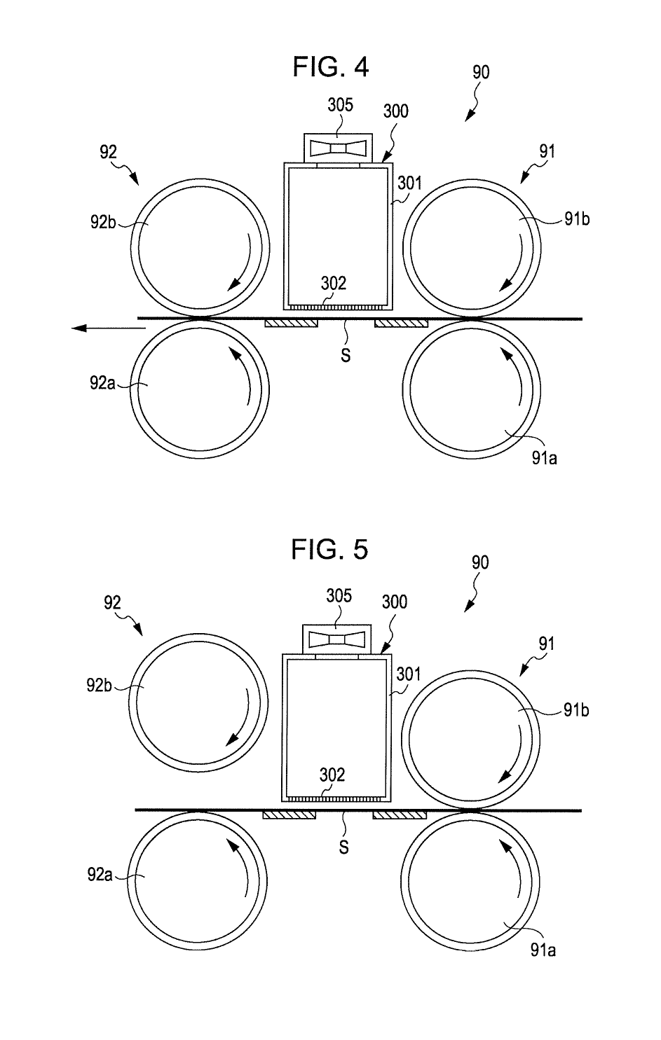

FIG. 4 is a cross-sectional view taken perpendicular to the axial direction of the fixing unit 90 that is in the state shown in FIG. 2, and FIG. 5 is a cross-sectional view taken perpendicular to the axial direction of the fixing unit 90 that is in the state shown in FIG. 3.

Next, a working example of the fixing unit 90 according to the first embodiment will be described. In the working example, the movement of the second pressure roller 92b is carried out in accordance with the paper type.

When printing onto heavy paper, and when performing single-sided printing, the paper passes through the first fixing roller pair 91 and the second fixing roller pair 92, and the fixing is carried out at a high strength, as shown in FIG. 4. Meanwhile, in double-sided printing, when printing onto a first surface of heavy paper, the paper passes through the first fixing roller pair 91 and the second fixing roller pair 92, as shown in FIG. 4. Then, when printing onto a second surface, which is the reverse surface of the first surface, the second pressure roller 92b is moved upwardly in the vertical direction, away from the second heating roller 92a, This movement reduces the pressure, as shown in FIG. 5. By reducing the amount of heat applied at a second fixing nip portion between the second pressure roller 92b and the second heating roller 92a in this manner, the process of melting of the toner that has formed an image due to the applied heat can be slowed.

Next, when printing onto light paper, heat has a strong influence, and thus the second pressure roller 92b is moved upwardly in the vertical direction, away from the second heating roller 92a. This movement reduces the pressure, as shown in FIG. 5, for both single-sided printing and double-sided printing. By reducing the amount of heat applied at the second fixing nip portion between the second pressure roller 92b and the second heating roller 92a in this manner, the process of melting of the toner that has formed an image due to the applied heat can be slowed.

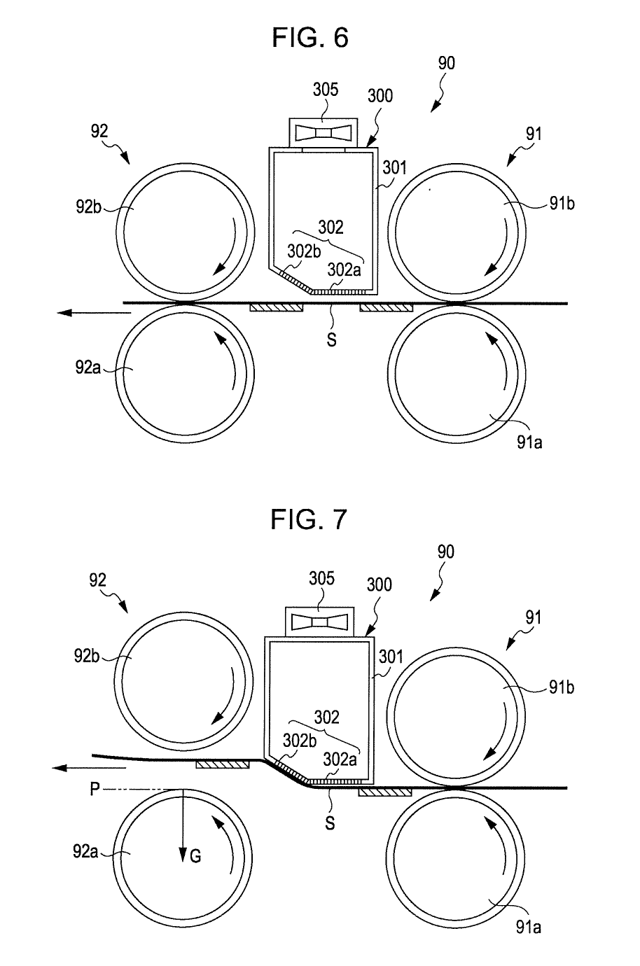

FIGS. 6 and 7 are diagrams illustrating an image forming apparatus according to a second embodiment. FIG. 6 is a cross-sectional view illustrating an example of the vicinity of the fixing unit 90 according to the second embodiment, and FIG. 7 is a cross-sectional view illustrating a state in which the second pressure roller 92b of the second fixing roller pair 92 has been moved upwardly in the vertical direction, according to the second embodiment.

In the image forming apparatus according to the second embodiment, the end of the fixing unit suction surface 302 of the fixing unit suction guide 300 on the side toward the second fixing roller pair 92 in the transport direction of the transfer material S is located higher in the vertical direction than the second fixing nip portion formed by the second heating roller 92a and the second pressure roller 92b of the second fixing roller pair 92 making contact with each other. Furthermore, the side of the fixing unit suction surface 302 toward the second fixing roller pair 92 in the transport direction of the transfer material S is located higher in the vertical direction than the side toward the first fixing roller pair 91 in the transport direction of the transfer material S.

With the fixing unit suction guide 300 according to the second embodiment, the fixing unit suction surface 302 includes a first fixing unit suction surface 302a and a second fixing unit suction surface 302b. On the side toward the first fixing roller pair 91, the first fixing unit suction surface 302a is formed so as to follow a line that connects the nip portions of the first fixing roller pair 91 and the second fixing roller pair 92. Meanwhile, the second fixing unit suction surface 302b is formed as a slope continuing from the side of the first fixing unit suction surface 302a onto the side toward the second fixing roller pair 92, so that the location of the second fixing unit suction surface 302b on the side toward the second fixing roller pair 92 is higher than a highest point P of the second heating roller 92a in a vertical direction G.

In this manner, part of the fixing unit suction surface 302 is formed as a slope so that the location of the second fixing unit suction surface 302b on the side toward the second fixing roller pair 92 is higher than the highest point P of the second heating roller 92a. Thus, impact of collisions between the leading edge of the transfer material S and the second heating roller 92a can be reduced even more in the current embodiment than in the first embodiment. The size of the image forming apparatus can be reduced as well.

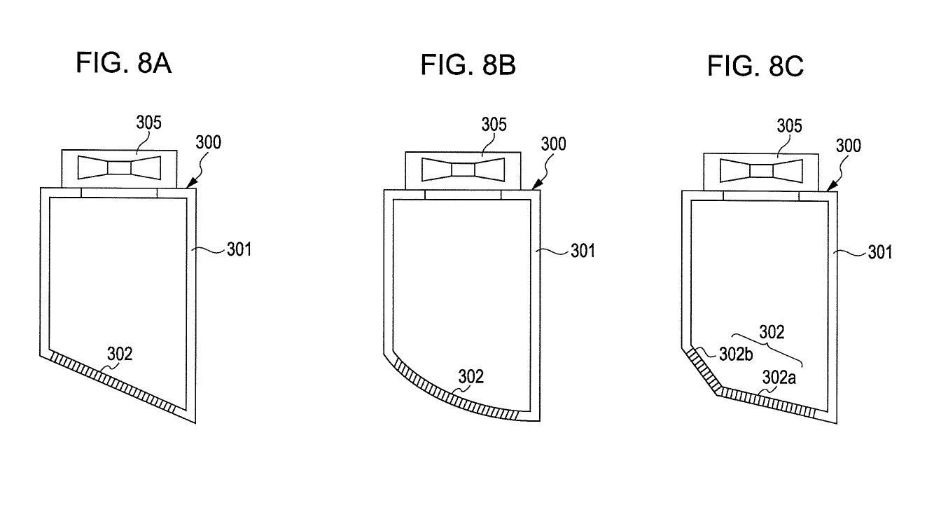

FIGS. 8A to 8C are diagrams illustrating examples in which the shape of the fixing unit suction surface 302 of the fixing unit suction guide 300 has been changed, according to the second embodiment. FIG. 8A is an example in which the fixing unit suction surface 302 of the fixing unit suction guide 300 has been formed so as to slope upwardly in the vertical direction, from the side toward the first fixing roller pair 91 to the side toward the second fixing roller pair 92, relative to the transport direction of the transfer material. Meanwhile, FIG. 8B is an example in which the fixing unit suction surface 302 slopes from the side toward the first fixing roller pair 91 to the side toward the second fixing roller pair 92 as an upward curve. Finally, FIG. 8C is an example in which the fixing unit suction surface 302 is formed from a first fixing unit suction surface 302a and a second fixing unit suction surface 302b that have slopes of different angles from the side toward the first fixing roller pair 91 to the side toward the second fixing roller pair 92.

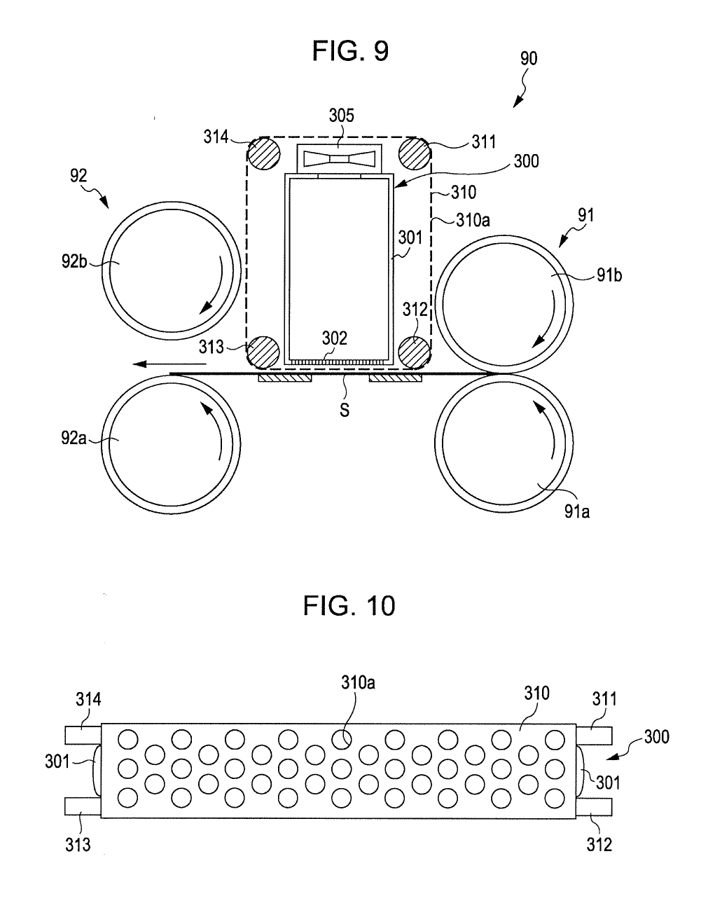

FIGS. 9 and 10 are diagrams illustrating a third embodiment. FIG. 9 is a diagram illustrating the fixing unit suction guide 300 according to the third embodiment, and FIG. 10 is a plan view illustrating the fixing unit suction guide 300 according to the third embodiment.

An image forming apparatus according to the third embodiment includes: a fixing unit transport belt 310 that forms a suction surface 302 and transports the transfer material S that has undergone fixing in the fixing unit 90; a driving roller 311 upon which the fixing unit transport belt 310 is wound and that drives the fixing unit transport belt 310; and a first slave roller 312, a second slave roller 313, and a third slave roller 314, upon which the fixing unit transport belt 310 is wound. The fixing unit transport belt 310 is wound around the driving roller 311, the first slave roller 312, the second slave roller 313, and the third slave roller 314, and is rotated in a direction that transports the transfer material S as the result of a driving unit (not shown) driving the driving roller 311.

In addition, holes 310a are provided in the fixing unit transport belt 310, and thus the suction force E acting at the fixing unit suction surface 302 due to airflow generated by the airflow generation unit 305 is not inhibited.

In this manner, by providing the fixing unit transport belt 310 in the periphery of the fixing unit suction guide 300, the transfer material S sticks to the fixing unit transport belt 310 and the transfer material S and the fixing unit transport belt 310 move together; as a result, the transfer material S can be transported from the first fixing roller pair 91 toward the second fixing roller pair 92 in a stable manner.

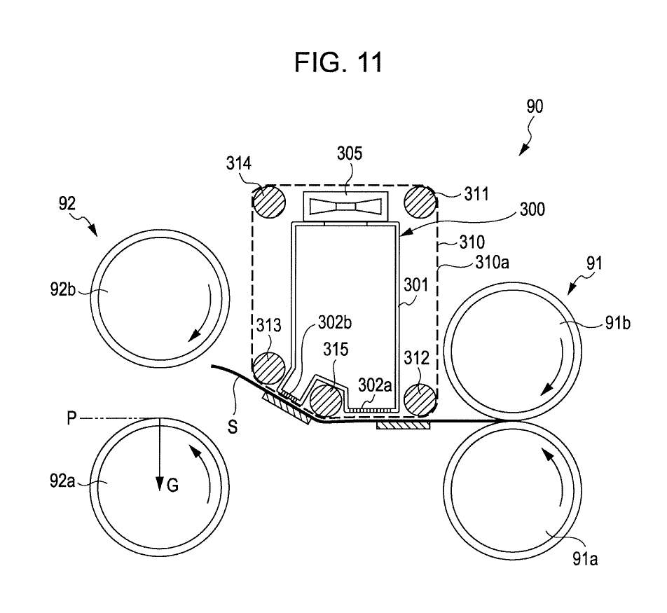

FIG. 11 is a diagram illustrating the fixing unit suction guide 300 according to a fourth embodiment.

In the image forming apparatus according to the fourth embodiment, the end of the fixing unit suction surface 302 of the fixing unit suction guide 300 on the side toward the second fixing roller pair 92 in the transport direction of the transfer material S is located higher in the vertical direction than the second fixing nip portion formed by the second heating roller 92a and the second pressure roller 92b of the second fixing roller pair 92 making contact with each other. Furthermore, the side of the fixing unit suction surface 302 toward the second fixing roller pair 92 in the transport direction of the transfer material S is located higher in the vertical direction than the side toward the first fixing roller pair 91 in the transport direction of the transfer material S.

With the fixing unit suction guide 300 according to the fourth embodiment, the fixing unit suction surface 302 includes the first fixing unit suction surface 302a and the second fixing unit suction surface 302b. On the side toward the first fixing roller pair 91, the first fixing unit suction surface 302a is formed so as to follow a line that connects the nip portions of the first fixing roller pair 91 and the second fixing roller pair 92. Meanwhile, the second fixing unit suction surface 302b is formed as a slope from the side of the first fixing unit suction surface 302a to the side toward the second fixing roller pair 92, so that the location of the second fixing unit suction surface 302b on the side toward the second fixing roller pair 92 is higher than the highest point P of the second heating roller 92a in the vertical direction G. Note that a fourth slave roller 315 is disposed between the first fixing unit suction surface 302a and the second fixing unit suction surface 302b.

In this manner, the fixing unit suction surface 302 is formed as a slope so that the location of the second fixing unit suction surface 302b on the side toward the second fixing roller pair 92 is higher than the highest point P of the second heating roller 92a. Thus, impact of collisions between the leading edge of the transfer material S and the second heating roller 92a can be reduced even more than in the third embodiment.

Note that the shape of the fixing unit suction surface 302 in the fixing unit suction guide 300 according to the fourth embodiment can also be altered as per the examples illustrated in FIG. 8.

In this manner, according to the fixing unit 90 of this embodiment, the influence of heat from the second heating roller 92a on the image surface can be reduced by using a simple configuration. In addition, according to the image forming apparatus of this embodiment, the influence of heat from the second heating roller 92a on the image surface can be reduced by using a simple configuration. It is possible to form a favorable image. In addition, the end of the fixing unit suction surface 302 of the fixing unit suction guide 300 on the side toward the second fixing roller pair 92 in the transport direction of the transfer material S is located higher in the vertical direction than a fixing nip portion formed by the second heating roller 92a and the second pressure roller 92b of the second fixing roller pair 92 making contact with each other, and it is thus possible to further reduce the influence of heat from the second heating roller 92a on the image surface.

Furthermore, the end of the fixing unit suction surface 302 is located higher in the vertical direction on the side toward the second fixing roller pair 92 in the transport direction of the transfer material S than on the side toward the first fixing roller pair 91 in the transport direction of the transfer material S, and it is thus possible to move the transfer material S in a smooth manner. In addition, because the fixing unit suction surface 302 progresses upwardly and continuously in the vertical direction, the transfer material S can be moved in an even smoother manner.

Meanwhile, because the image forming apparatus includes the fixing unit transport belt 310 that forms the suction surface 302 and transports the transfer material S that has undergone fixing in the fixing unit 90, the driving roller 311 upon which the fixing unit transport belt 310 is wound and that drives the fixing unit transport belt 310, and the slave rollers 312 to 315 upon which the fixing unit transport belt 310 is wound, the transfer material S sticks to the fixing unit transport belt 310 and the transfer material S and the fixing unit transport belt 310 move together. As a result, the transfer material S can be transported from the first fixing roller pair 91 toward the second fixing roller pair 92 in a stable manner.

Furthermore, because the fixing unit transport belt 310 includes the holes 310a through which air flows, the transfer material S can be transported in an even more stable manner.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A fixing apparatus comprising:
a first fixing roller unit including a first heating roller that heats a transfer material bearing an image and a first pressure roller that is in contact with the first heating roller;
a suction guide that guides the transfer material, the suction guide including a suction surface that vertically upwardly sucks the transfer material after being heated by the first fixing roller unit with a surface of the transfer material that bears the image facing vertically down;
a second fixing roller unit that fixes the transfer material after being guided by the suction guide, the second fixing roller unit including a second heating roller that heats the transfer material, and a second pressure roller that is disposed above the second heating roller in the vertical direction and is in contact with the second heating roller; and
a movement member that causes the second pressure roller to move vertically upwardly.

2. An image forming apparatus comprising:
a latent image bearing member that bears a latent image;
a developing unit that develops the latent image using a liquid developer including toner and a carrier liquid;
a transfer medium on which the image developed on the latent image bearing member by the developing unit is transferred;
a transfer roller that is in contact with the transfer medium, forms a nip portion with the transfer medium, and transfers the image to the transfer material;
a fixing unit including
a first fixing roller unit including a first heating roller that heats the transfer material bearing the image and a first pressure roller that is in contact with the first heating roller,
a suction guide that guides the transfer material, the suction guide including a suction surface that vertically upwardly sucks the transfer material after being heated by the first fixing roller unit with a surface of the transfer material that bears the image facing vertically down, and
a second fixing roller unit that fixes the transfer material after being guided by the suction guide, the second fixing roller unit including a second heating roller that heats the transfer material, and a second pressure roller that is disposed above the second heating roller in the vertical direction and is in contact with the second heating roller; and
a movement member that causes the second pressure roller to move vertically upwardly.

3. The image forming apparatus according to claim 2, wherein
a first end of the suction surface being closer to the second fixing roller unit than to the first fixing roller unit is located higher in the vertical direction than a second fixing nip portion formed by the second heating roller and the second pressure roller.

4. The image forming apparatus according to claim 3, wherein
the first end is located higher in the vertical direction than a second end being closer to the first fixing roller unit than to the second fixing roller unit.

5. The image forming apparatus according to claim 4, wherein
the suction surface upwardly slopes from the second end to the first end in a transport direction of the transfer material.

6. The image forming apparatus according to claim 2, further comprising
a transport belt that forms the suction surface and transports the transfer material on which the image is fixed at the first fixing unit;
a driving roller that the transport belt is wound and that drives the transport belt; and
a slave roller that the transport belt is wound.

7. The image forming apparatus according to claim 6, wherein the transport belt has a hole through which air flows.
